(19) United States
(12) Patent Application Publication
(10) Pub. No.: US 2005/0212191 A1
(43) Pub. Date: Sep. 29, 2005

(54) Apparatus for rotating a vehicle

(76) Inventors: Victor L. McKelvie, Quesnel (CA); Ronald Meyers, Quesnel (CA)

Correspondence Address: ANTONY C. EDWARDS, SUITE 200 - 270 HIGHWAY 33 WEST, KELOWNA, BC, V1X 1X7, CA

(21) Appl. No.: 11/087,551

(22) Filed: Mar. 24, 2005

(30) Foreign Application Priority Data
Mar. 24, 2004 (CA) 2,460,980

(51) Int. Cl. B25B 1/00

(52) U.S. Cl. 269/17

(57) ABSTRACT

An apparatus for rotating a vehicle such as an automobile is disclosed. The apparatus includes a first and a second substantially circular frame detachably mounted to a base frame in a parallel spaced apart orientation. A plurality of mounting members adjustably mounted to the first and second frame are configured to engage a support structure of the vehicle to detachably mount the vehicle to the first and second frame. The plurality of mounting members may be adjustable to engage the vehicle at a plurality of different positions so as to provide virtually complete access to an underside of the vehicle. A plurality of rotatable bearings mounted to the base frame engages the first and second frame such that the first and second frame may freely rotate on the plurality of bearings in a first and a second direction. The first and second frame rotates simultaneously relative to the base frame which rests stationary on a surface. A plurality of releasable locking mechanisms mounted to the base frame engages the first and second frame to inhibit rotation when the first and second frame are rotated to a desired degree of rotation. Wheels may be mounted to the apparatus so as to make it transportable.

### CROSS REFERENCE TO RELATED APPLICATION

This application claims priority from Canadian Patent Application No. 2,460,980 filed Mar. 24, 2004 entitled ROTOBOD.

### FIELD OF THE INVENTION

The present invention relates to the field of support structures for a vehicle, and more particularly, it relates to an apparatus for supporting and rotating a vehicle to facilitate performing repair and restoration on the vehicle.

### BACKGROUND OF THE INVENTION

Repair and restoration of any vehicle typically requires access to the lower portion and/or underside of the vehicle. For example, to prepare a car for body work such as painting, the surface rust and the undercoating on the underside of the car must be removed by various means such as sandblasting before a new coat of paint may be applied. To repair damage to the hull of a boat, a workperson usually needs to be able to access the damaged area under the boat. Access to the lower surface of a jetski is also necessary to repair or replace mechanical drive components. If the vehicle is maintained in an upright position during the repair or restoration process, the underside and/or specific areas of the underside of the vehicle may be relatively inaccessible or difficult to reach. Typically, the vehicle is elevated in a manner such that a workperson may work on the vehicle positioned above his/her head. Not only is such position awkward and tiring for the workperson, but depending on the type of work being done to the underside of the vehicle, it may also affect the quality of the work For example, any solvent placed on the underside of a car to dissolve or clean the underside may not be as effective due to gravity causing the solvent to drip downwardly.

Smaller vehicles such as boats, snowmobiles, jetskis may be inverted or tilted to expose the underside. However, smaller vehicles may still be fairly heavy and difficult to manually invert. Furthermore, even with secondary supports to help bear the weight of the vehicle, the vehicle may still be placed in an unstable or unbalanced position which places undue stress on the body of the vehicle, thereby causing damage.

Applicant is aware of U.S. Pat. No. 1,507,911 to Eichman which describes a gripping carrier having holding means so that an automobile can be readily mounted while the carrier is turned for inspection or repair purposes. The carrier includes a pair of spaced apart circular-shaped frames. A pair of spaced apart rails for locating the tires of a vehicle positioned on the carrier extends between and connects the pair of spaced apart circular-shaped frames. The circular-shaped frames rest in grooved rollers mounted in short shafts held in bearings such that the circular-shaped frames may be readily tilted. The vehicle is held in place by a plurality of chain clamps having end hooks for holding the vehicle frame to the carrier. Although the carrier described in Eichman allows for the automobile to be turned or tilted, the carrier includes rails that impede access to various portions of the underside of the automobile such as the suspension system.

Applicant is also aware of U.S. Pat. No. 1,288,138 to Nicoson which describes an adjustable automobile holder for adjustably holding a vehicle, especially an automobile, to enable a workman to have access to the under portions or mechanisms of the vehicle. The holder includes two rocker members that are spaced apart a distance approximately equal to the space between the axles of the automobile. The rocker members have a straight base portion that normally rests on the ground to enable the members to normally stand upright in a balanced position. The rocker members also have curved portions so that they may be rolled over onto either side. The rocker members support two track rails that are suitably spaced apart for locating the wheels of the vehicle when mounted on the holder. Flanges mounted to the track rails assist to prevent the wheels of the vehicle from sliding from the rails when the holder is adjusted so as to tilt the vehicle. Securing devices are provided to secure the vehicle in the holder when the holder is tilted side to side. When the holder is tilted, it may be secured against movement by means of chock blocks. Although the Nicoson patent describes an adjustable structure for holding a vehicle that may be tilted, the adjustable structure includes a pair of track rails that obstruct access to parts of the underside of the vehicle, such as the suspension system of the vehicle. Furthermore, the adjustable structure requires substantial side clearance or free space on either side of the structure to allow the structure to tilt.

Applicant is also aware of U.S. Pat. No. 5,752,408 to Huckabee which describes a support structure for carrying a vehicle body. The support structure includes a pair of spaced apart frames positioned about a front and rear end of the vehicle body. Each frame is octagon shaped formed by joined elongated members. A cross bar assembly of each frame includes a pair of mounts that are attached to mounting structure of the vehicle. The frames are positioned horizontally so that bottom sections of the frames may be slid under respective slightly raised ends of the vehicle body. Once the vehicle is secured to the frames, the support structure and vehicle may be rolled over to locate the body as required. Although the Huckabee patent describes a support structure for carrying a vehicle body that may be rolled over to expose the underside of the vehicle, the support structure may only be rotated in fixed increments of forty five degrees. Furthermore, the support structure requires ample space and side clearance in order to rotate the support structure for example, from a first side of the octagon to a fourth side of the octagon to fully expose the underside of the vehicle.

Therefore, it is an object of the present invention to provide an apparatus for rotating a vehicle that can give a workperson almost complete access to the underside of a vehicle. The present invention also allows for stationary rotation of the vehicle in virtually any degree of rotation such that the vehicle may be repaired or restored in any typical standard automotive repair space without need for additional space or clearance to rotate the vehicle. Furthermore, the present invention allows the workperson to safely and easily manoeuvre or move the vehicle to a second location while mounted on the apparatus.

### SUMMARY OF THE INVENTION

In accordance with the present invention, the apparatus for rotating a vehicle includes a first and a second substantially circular frame detachably mounted to a base frame in a parallel spaced apart orientation. A plurality of mounting members adjustably mounted to the first and the second substantially circular frame are adjustable to engage a support structure of the vehicle to detachably mount the vehicle to the first and the second substantially circular frame. In a preferred embodiment of the invention, a plurality of pinch weld mounting members are adjustably mounted to the first and the second substantially circular frame to detachably mount the vehicle to said first and said second substantially circular frame. The pinch weld mounting members are adjustable to engage a rocker panel pinch weld on both sides of the vehicle. A plurality of rotatable bearings are mounted to the base such that the first and the second substantially circular frame engages and may freely rotate simultaneously on the plurality of rotatable bearings in a first and a second direction when the first and second substantially circular frame are mounted to the base. When the first and second substantially circular frame are rotated to the desired degree of ration, a plurality of releasable locking mechanisms mounted to the base frame engages the first and the second circular frame. When the locking mechanisms are released, the first and the second circular frame may freely rotate again. The first and the second circular frame rotates relative to the base frame which rests stationary on a surface. The plurality of mounting members are adjustable to engage the vehicle at a plurality of different positions so as to provide virtually complete access to an underside of the vehicle. In a preferred embodiment of the invention, the plurality of pinch weld mounting members may be adjustably mounted to a plurality of different locations along the rocker panel pinch weld so as to provide virtually complete access to an underside of the vehicle.

In an embodiment of the invention, an upper planar cross member forms at an upper portion of each of the first and the second substantially circular frame. A first sleeve member is mounted to a first and a second end of each upper cross member. Each of the first sleeve members are configured to adjustably receive a first and a second upper side bar that extends between the first and the second substantially circular frame such that the distance between the first and the second substantially circular frame is adjustable. The first and the second substantially circular frame also includes a lower planar cross member extending between a lower curved portion of each of the first and the second substantially circular frame. A pair of adjustable sleeve members is mounted to each of the lower cross members such that each pair of adjustable sleeve members may translate in a first and a second direction along the lower cross member so as to adjust the distance between the pair of adjustable sleeve members. In an embodiment of the invention, each of the adjustable sleeve members support one of the plurality of mounting members configured to engage the support structure of the vehicle. Preferably, the mounting members are pinch weld mounting members configured to engage and secure onto a rocker panel pinch weld of an automobile.

The base frame includes a pair of end bars in a parallel spaced apart orientation and a pair of lower side bars in a parallel spaced apart orientation. The pair of lower side bars is adjustably coupled with the pair of end bars so as to form a generally rectangular base frame. A second sleeve member is mounted to a first and a second exterior end of each end bar. Each of the second sleeve members are configured to adjustably receive the side bars such that the position of the mounting members may be adjustable relative the longitudinal length of the rocker panel pinch weld. In an embodiment of the invention, a wheel may be attached to each end of the pair of lower side bars so as to enable the apparatus to be transported to another location while the vehicle is mounted to the apparatus.

The apparatus also includes a pair of support plates mounted to a first and a second interior end of each end bar. At an upper end, each pair of support plates rotatably supports one of the plurality of rotatable bearings by way of a pivot pin. The upper end of each support plate extends above each bearing so as to provide a guide to inhibit disengagement of the first and the second circular frame with the bearings. A pair of centre plates is mounted to a generally central region of each end bar. The pair of centre plates supports one of the plurality of releasable locking mechanisms. The locking mechanism includes a pair of corresponding apertures on an upper end of each pair of centre plates and a bolt that may journal through the pair of apertures. The first and the second substantially circular frame include a plurality of corresponding apertures which correspond to the different degrees of rotation. The apertures on the first and the second circular frame corresponds with the pair of apertures on each pair of centre plates such that the bolt may journal through the apertures on the first and the second substantially circular frame and the pair of centre plates so as to lock the first and the second substantially circular frame in a desired degree of rotation.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a side perspective view of an embodiment of the apparatus for rotating a vehicle;

FIG. 2 is rear view of the apparatus for rotating a vehicle as seen in FIG. 1; and

FIG. 3 is a side perspective view of the apparatus for rotating a vehicle depicted in FIG. 1 that has been rotated;

FIG. 4 is a side perspective view of an automobile mounted to the apparatus for rotating a vehicle depicted in FIG. 1;

FIG. 5 is a rear view of the automobile mounted to the apparatus for rotating a vehicle as seen in FIG. 4;

FIG. 6 is a side perspective view of the automobile mounted to the apparatus for rotating a vehicle depicted in FIG. 4 that has been rotated;

FIG. 7 is a side perspective view of an underside of the automobile mounted to the apparatus for rotating a vehicle as seen in FIG. 6; and

FIG. 8 is an enlarged view of a mounting member engaging the rocker panel pinch weld of the automobile.

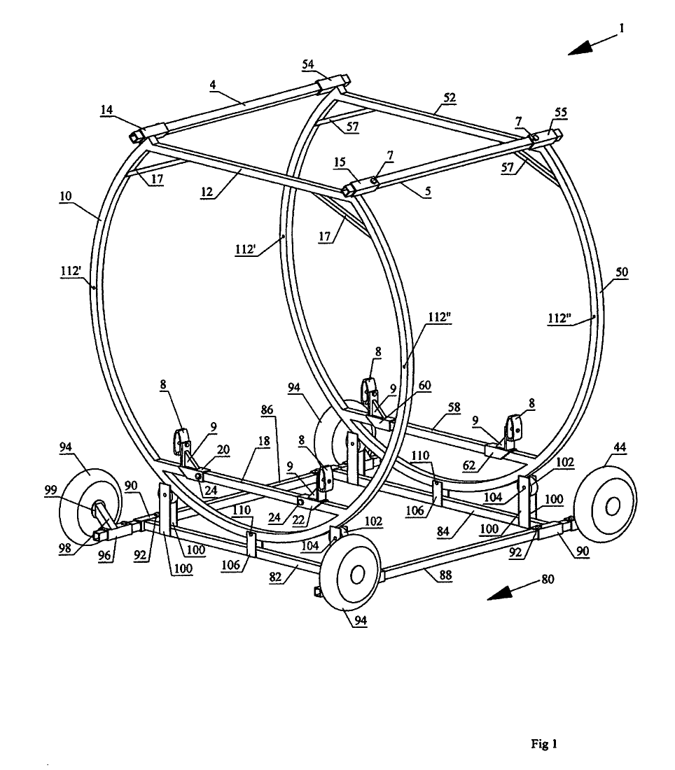

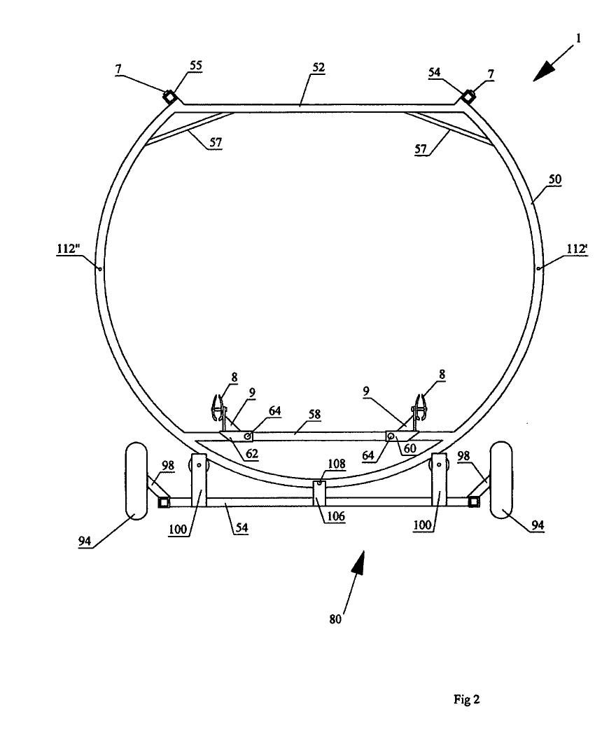

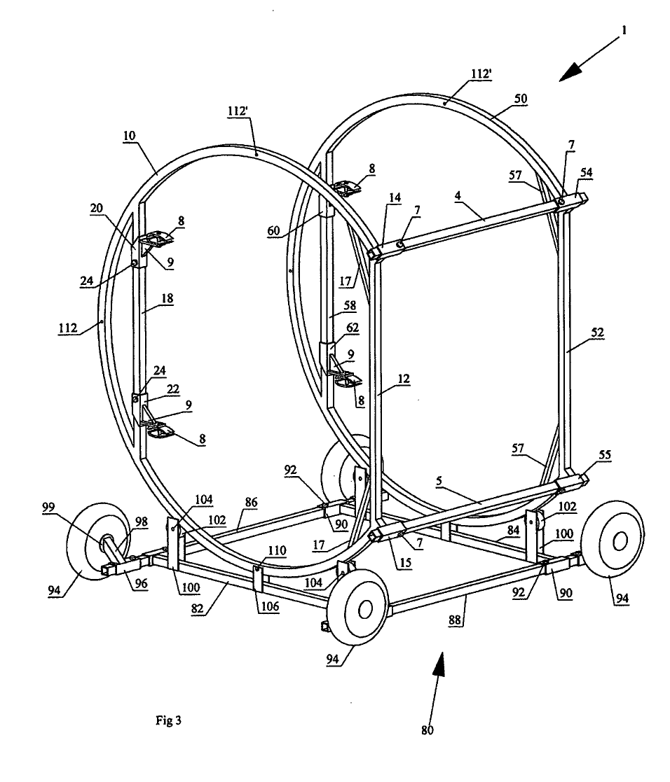

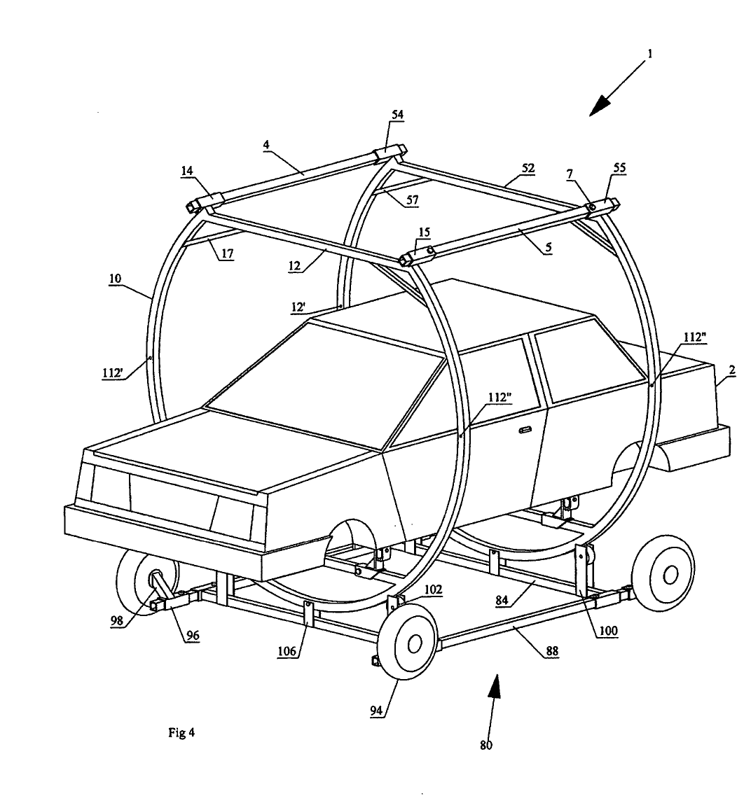

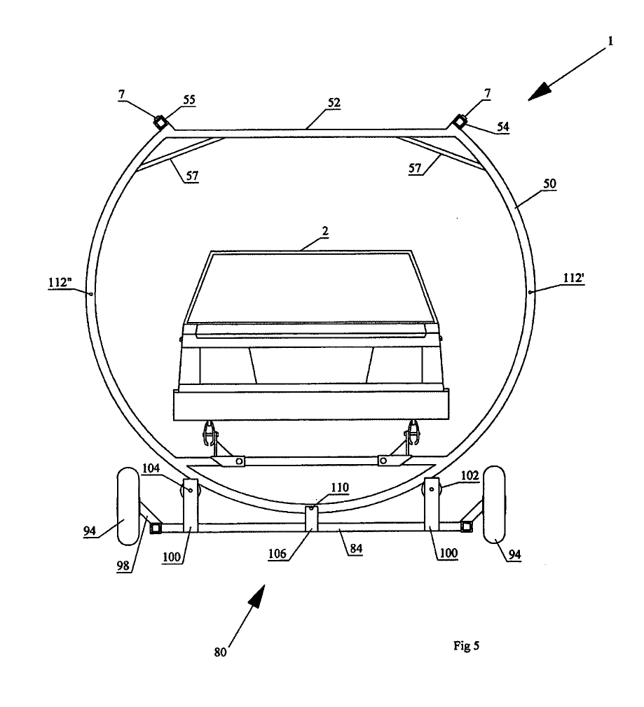

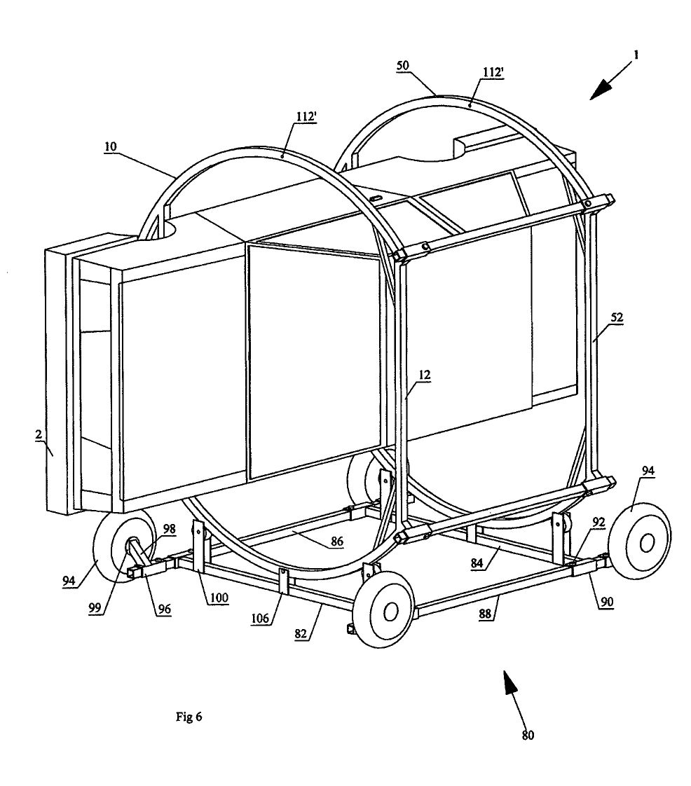

### DETAILED DESCRIPTION OF EMBODIMENTS OF THE INVENTION

With reference to the drawings wherein similar characters of reference denote corresponding parts in each view, the apparatus for rotating a vehicle 1 includes a first frame 10 and a second frame 50. In an embodiment of the present invention, first frame 10 is substantially circular having a generally planar upper cross member 12 and second frame 50 is substantially circular having a generally planar upper cross member 52. Preferably, first frame 10 and second frame 50 are made from two inch square steel tubing that is one eighth inch thick. The steel tubing may be bent to form identical substantially circular hoops with an upper planar cross member. In an alternative embodiment of the invention, the steel tubing may be bent to form identical complete circular hoops without an upper planar cross member. In the embodiment wherein first frame 10 and second frame 50 each include an upper cross member, first frame 10 and second frame 50 may rotate at least 120° in either direction whereas in the embodiment wherein first frame 10 and second frame 50 are completely circular, first frame 10 and second frame 50 may rotate 360° in either direction Alternatively, first frame 10 and second frame 50 may be made from any rigid material of any diameter so long as it is sufficiently strong to support the weight of the vehicle mounted to apparatus 1, as better described below. Apparatus 1 may be configured to support virtually any type of vehicle such as an automobile, a boat, a jetski, or a snowmobile although preferably, apparatus 1 supports an automobile 2.

Mounted to a first and a second end of upper cross member 12 are receiving means 14 and 15. Similarly, mounted to a first and a second end of upper cross member 52 are receiving means 54 and 55. In the alternative embodiment wherein first frame 10 and second frame 50 are completely circular such that first frame 10 and second frame 50 may rotate 360° in either direction, receiving means 14, 15 and 54, 55 may be mounted to an inner surface of an upper portion of first frame 10 and second frame 50. Preferably, receiving means 14, 15 and 54, 55 are sleeves configured to receive side bar 4 and 5 that extend between first frame 10 and second frame 50. Side bars 4, 5 thereby connect the upper portion of first frame 10 with the upper portion of second frame 50. In an embodiment of the invention, sleeves 14, 15 are welded to upper cross member 12 such that sleeves 14, 15 are perpendicular to upper cross member 12 and sleeves 54, 55 are welded to upper cross member 52 such that sleeves 54, 55 are perpendicular to upper cross member 52. Sleeves 14, 15 and 54, 55 correspond with the configuration of side bars 4, 5 such that sleeves 14, 15 and 54, 55 snugly receive side bars 4, 5. Preferably, side bars 4, 5 are made of the same square steel tubing as first frame 10 and second frame 50. Preferably, sleeves 14, 15 and 54, 55 are generally rectangular and mounted to upper cross member 12 and upper cross member 52, respectively such that a first end of each sleeve 14, 15 and 54, 55 extend approximately five and a half inches from upper cross member 12 and upper cross member 52, respectively. In an embodiment of the invention, a rigid bar 17 may be mounted between an upper portion of first frame 10 and each end of upper cross member 12. Similarly, a rigid bar 57 may be mounted between an upper portion of second frame 50 and each end of upper cross member 52. Rigid bar 17 and 57 may be mounted so as to re-enforce and provide additional structural support to the upper portions of first frame 10 and second frame 50, respectively.

In an embodiment of the invention, sleeves 14, 15 and 54, 55 each include releaseably securable fastening means 7 such as a clamp, bolt, or a screw for adjustably securing side bars 4, 5 in a plurality of different positions such that the distance between frame 10 and frame 50 may be adjusted. Side bars 4, 5 may journal through sleeves 14, 15 and 54, 55 respectively when fastening means 7 are released to allow movement of side bars 4, 5 through sleeves 14, 15 and 54, 55 to a desired position. Preferably, fastening means 7 are screws that may be released such that sleeves 14 and 54 may translate along side bar 4 and sleeves 15 and 55 may translate along side bar 5. Screws 7 may then be tightened such that screws 7 frictionally engage side bars 4, 5 to secure side bars 4, 5 in the desired position The distance between first frame 10 and second frame 50 may be adjusted so as to accommodate different lengths of the vehicle to be mounted to and supported by apparatus 1. Preferably, first frame 10 and second frame 50 are generally spaced apart at a distance approximately equal to the space between the axles of automobile 2.

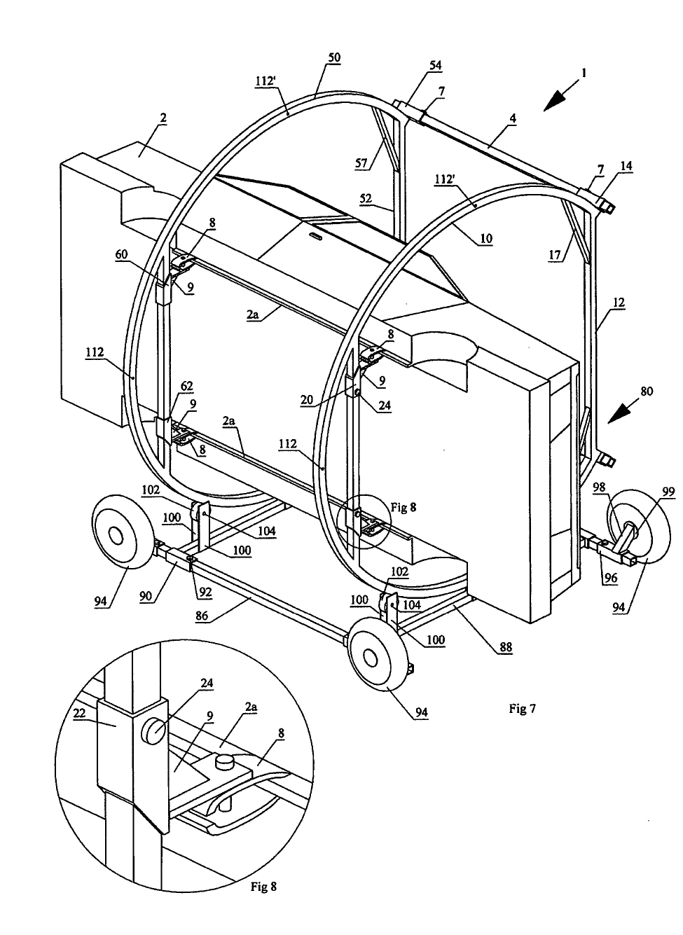

First frame 10 and second frame 50 also includes a lower cross member 18 and 58, respectively. Preferably, lower cross members 18, 58 are made of the same square steel tubing as first frame 10 and second frame 50. Lower cross member 18 includes a pair of adjustable sleeves 20 and 22, each having a releaseably securable fastening means 24 such as a clamp or screw so as to enable the adjustment of the position of adjustable sleeves 20, 22 along lower cross member 18. Similarly, lower cross member 58 includes a pair of adjustable sleeves 60 and 62 each having a releaseably securable fastening means 64 such as a clamp or screw so as to enable the adjustment of the position of adjustable sleeves 60, 62 along lower cross member 58. Mounted to each adjustable sleeve 20, 22 and 60,62 is a mounting means 8 such as a machine clamp, a pulling clamp, or any other clamping mechanism that may be coupled with and secured onto a support structure of a vehicle. In a preferred embodiment wherein automobile 2 is to be mounted on apparatus 1, mounting means 8 are clamshell-style clamps such as so-called Scott clamps which are configured to clamp onto or couple with the rocker panel pinch welds 2a on each side of automobile 2 as better seen in FIG. 7. Mounting means 8 may be any pinch weld mounting means that are suitable for securing onto the rocker panel pinch welds 2a of an automobile. Advantageously, because the rocker panel pinch welds 2a of automobile 2 are the strongest structure of the frame of automobile 2, mounting automobile 2 to apparatus 1 by securing mounting means 8 to the rocker panel pinch welds 2a substantially eliminates the possibility of body sag. In an embodiment of the invention, each mounting means 8 is coupled to a gusset 9 which is mounted on each adjustable sleeve 20, 22 and 60, 62. Preferably, gusset 9 is welded to each adjustable sleeve 20, 22 and 60, 62 such that mounting means 8 coupled with adjustable sleeve 20 is in parallel spaced apart alignment with respect to mounting means 8 coupled with adjustable sleeve 22 and mounting means 8 coupled with adjustable sleeve 60 is in parallel spaced apart alignment with respect to mounting means 8 coupled with adjustable sleeve 62.

Fastening means 24 and 64 may be released such that adjustable sleeves 20, 22 and 60, 62 may be translated along lower cross members 18, 58 respectively, such that that the distance between the pair of mounting means 8 on lower cross members 18, 58 may be adjusted. Preferably, fastening means 24, 64 are screws that may be released such that adjustable sleeves 20, 22 may translate along lower cross member 18 and adjustable sleeves 60, 62 may translate along lower cross member 58. Screws 24, 64 may then be tightened such that screws 24, 64 frictionally engage lower cross members 18, 58 respectively to secure adjustable sleeves 20, 22 and 60, 62 in the desired position. The distance between the pair of mounting means 8 on lower cross members 18, 58 may be adjusted so as to accommodate different widths of the vehicle to be mounted to and supported by apparatus 1.

First frame 10 and second frame 50 are detachably mountable to base frame 80. Base frame 80 includes a pair of end bars 82 and 84 and a pair of side bars 86 and 88 that may be adjustably coupled together by way of mounting sleeves 90 to form a generally rectangular shaped base frame 80. Preferably, end bars 82, 84 are made from two and a half inch square steel tubing that is one eight inch thick and side bars 86, 88 are made of the same steel tubing as first frame 10 and second frame 50. Mounted to a first and a second exterior end of end bars 82, 84 are mounting sleeves 90 configured to receive side bars 86, 88 that extend between end bars 82, 84 in a parallel spaced apart orientation. Side bars 86, 88 received within mounting sleeves 90 thereby connect end bars 82, 84 to form the generally rectangular shaped base frame 80. In an embodiment of the invention, mounting sleeves 90 are welded to the first and second ends of end bars 82, 84 such that mounting sleeves 90 are generally perpendicular to end bars 82, 84. Mounting sleeves 90 correspond with the configuration of side bars 86, 88 such that mounting sleeves 90 snugly receive side bars 86, 88. Preferably mounting sleeves 90 are generally rectangular and mounted to the first and second ends of end bars 82, 84 such that a first end of each mounting sleeve 90 extends approximately five and a half inches from end bars 82, 84.

In an embodiment of the invention, mounting sleeves 90 include releaseably securable fastening means 92 such as a clamp or a screw for adjustably securing side bars 86, 88 in a plurality of different positions so as to adjust the distance between end bars 82, 84 to accommodate and support the orientation of first frame 10 and second frame 50 when first frame 10 and second frame 50 are mounted on base frame 80. Side bars 86, 88 may journal through mounting sleeves 90 when fastening means 92 are released to allow movement of side bars 86, 88 through mounting sleeves 90. Preferably, fastening means 92 are screws that may be released such that mounting sleeves 90 may translate along of side bars 86, 88. Screws 92 may then be tightened such that screws 92 frictionally engage side bars 86, 88 to secure side bars 86, 88 in a desired position. The distance between end bars 82, 84 may be adjusted so as to accommodate the distance between first frame 10 and second frame 50 which may vary depending on the length of the vehicle to be mounted to and supported by apparatus 1. The distance between end bars 82, 84 may also be adjusted so as to adjust the position where mounting means 8 are coupled with and secured onto the rocker panel pinch welds on each side of automobile 2. Advantageously, the adjustability of mounting means 8 along the length of the rocker panel pinch welds 2a on each side of automobile 2 enables a worker to have virtually complete access of the underside of automobile 2. For example, if the original mounting position of any of the mounting means 8 on the rocker panel pinch welds 2a is obstructing access to a certain portion of the underside of automobile 2, fastening means 92 may be released to adjust the position of end bars 82 and/or 84 so as to enable securing means 8 to couple with the rocker panel pinch welds 2a at an alternative mounting position.

Preferably, side bars 86, 88 are of sufficient length so as to enable the attachment of wheels 94 such that apparatus 1 may be transportable to any suitable location. Wheels 94 may be mounted to both ends of side bars 86, 88 by way of a sleeve 96. Sleeve 96 is substantially identical to mounting sleeve 90. Each wheel 94 may be mounted to sleeve 96 by way of a wheel support bar 98. At a first end, wheel support bar 98 is mounted to the spindle 99 of each wheel 94 and at a second end, wheel support bar 98 is mounted to sleeve 96. The length of wheel support bar 98 may be varied to accommodate different sizes of wheels 94. King pins may be provided so as to enable wheels 94 to steer.

Mounted to an interior first and an interior second end of end bars 82, 84 are a pair of support plates 100. Support plates 100 are preferably made of steel or any rigid and strong material that may support the weight of the vehicle to be mounted to apparatus 1. Rotatably mounted to an upper end of each pair of support plates 100, by way of a pivot pin 104, is a bearing or roller 102. In an embodiment of the invention, a lower end of each pair of support plates 100 are mounted to both ends of end bars 82, 84 such that end bars 82, 84 are sandwiched between each pair of support plates 100. Support plates 100 extend vertically upwards from and generally perpendicular to end bars 82, 84 such that when first frame 10 and second frame 50 are mounted onto base frame 80, there is adequate clearance between base frame 80 and the lowest point of curvature of first frame 10 and second frame 50. For greater clarity, bearings 102 rotatably support first frame 10 and second frame 50 such that first frame 10 and second frame 50 may rotate on bearings 102 without frictionally engaging any part of base frame 80 when first frame 10 and second frame 50 are mounted on base frame 80. The upper portion of support plates 100 also function as guides to ensure that first frame 10 and second frame 50 maintains engagement with bearings 102, especially during rotation. Advantageously, first frame 10 and second frame 50 may rotate on base frame 80 without requiring additional space to accommodate the rotation distance of first frame 10 and second frame 50.

A pair of centre plates 106 is mounted to the generally central region of end bars 82, 84. Centre plates 106 are preferably made of the same material as support plates 100. Each pair of centre plates 106 defines apertures 108 on an upper end of each centre plate 106. Apertures 108 on each centre plate 106 are aligned such that a bolt 110 may journal through apertures 108 of each pair of centre plates 106. In an embodiment of the invention, a lower end of each pair of centre plates 106 are mounted to the central region of end bars 82, 84 so as to sandwich end bars 82, 84 between each pair of centre plates 106. Centre plates 106 extend vertically upwards from and generally perpendicular to end bars 82, 84. Apertures 108 correspond with a plurality of apertures 112 on first frame 10 and second frame 50 such that bolt 110 may journal through apertures 108 and one of the plurality of apertures 112 so as to lock first frame 10 and second frame 50 in a desired degree of rotation. The plurality of apertures 112 on first frame 10 and second frame 50 correspond to each other which also correspond to various degrees of rotation. In an embodiment of the invention, first frame 10 and second frame 50 includes three apertures 112, 112′ and 112″ such that first frame 10 and second frame 50 may be simultaneously rotated at ninety degree intervals on either side of level. However, first frame 10 and second frame 50 may include a plurality of apertures 112 that correspond to increments of smaller degrees of rotation. For example, each aperture of the plurality of apertures 112 may be spaced apart at least half an inch on first frame 10 and second frame 50. In addition to locking first frame 10 and second frame 50 in a desired position, centre plates 106 and bolt 110 also provides support to the lowest point of curvature of first frame 10 and second frame 50 when bolt 110 locks first frame 10 and second frame 50 to base frame 90.

To mount automobile 2 on apparatus 1, first frame 10 and second frame 50 is first mounted to base frame 90. With first frame 10 laying horizontally such that sleeves 14, 15 are vertical, first frame 10 is attached to end bar 82 by engaging first frame 10 with bearings 102 mounted on end bar 82 and inserting bolt 110 through apertures 108 and aperture 112′ on first frame 10. Second frame 50 is similarly attached to end bar 84 by engaging second frame 50 with bearings 102 mounted on end bar 84 and inserting bolt 110 through apertures 108 and aperture 112′ on second frame 50. By inserting bolt 110 through aperture 112′, first frame 10 and second frame 50 are thereby secured or locked in a position wherein automobile 2 may be mounted to apparatus 1 at a level position.

Next, position first frame 10 in its horizontal orientation adjacent to the front end of automobile 2 and position second frame 50 in its horizontal orientation adjacent to the rear end of automobile 2. To mount automobile 2 to first frame 10 and second frame 50, automobile 2 must be raised by conventional means such as a jack to enable first frame 10 and second frame 50 to be positioned under automobile 2. Position first frame 10 under the front end of automobile 2 and insert the first end of side bars 86, 88 in mounting sleeves 90 on both ends of end bar 82. Raise first frame 10 to its vertical position such that side bars 86, 88 engages the ground so as to maintain first frame 10 in its vertical position. Position second frame 50 under the rear of automobile 2 and raise second frame 50 to its vertical position. Insert the second ends of side bars 86, 88 in mounting sleeves 90 on both ends of end bar 84. Ensure there is sufficient length at the ends of side bars 86, 88 for attaching wheels 94 is desired before tightening fastening means 92. Also, adjust first frame 10 and second frame 50 according to the length and width of the automobile to ensure that mounting means 8 are substantially adjacent to the wheel base of automobile 2 before tightening fastening means 92. Adjust the position of mounting means 8 by way of releasing and tightening fastening means 24, 64 to enable mounting means 8 to be secured onto the rocker panel pinch welds on each side of automobile 2. Lower automobile 2 to secure all mounting means 8 onto the rocker panel pinch welds of automobile 2 at a position substantially adjacent to the wheel base of automobile 2. Insert side bars 4, 5 into sleeves 14, 15 and 54, 55. Make any necessary adjustments to accommodate the length and width of automobile 2 by way of adjusting side bars 4, 5, side bars 86, 88, and securing means 8 so as to centre automobile 2 in apparatus 1.

Automobile 2 is now securely mounted on apparatus 1. Base frame 80 rests firmly on the floor or ground such that first frame 10 and second frame 50 may be rotated to rotate automobile 2 while apparatus 1 remains stationary. Alternatively, base frame 80 may be raised by conventional means, such as a jack, to mount wheels 94 to the ends of side bars 86, 88. Wheels 94 may also be locked so that first frame 10 and second frame 50 may be rotated with wheels 94 mounted to the ends of side bars 86, 88. To rotate the vehicle, comealong hooks or other similar tools known in the trade may be attached to a generally central region of side bars 4 or 5 and side bars 86 or 88, depending on the desired direction of rotation. Remove bolts 110 such that first frame 10 and second frame 50 may freely rotate on bearings 102. Bring side bar 4 towards side bar 86 or bring side bar 5 towards side bar 88 until automobile 2 is positioned in the desired degree of rotation and apertures 108 align with one of the plurality of apertures 112 on first frame 10 and second frame 50. Reinsert bolt 110 to secure the position of first frame 10 and second frame 50. Remove the comealongs.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. An apparatus for rotating a vehicle, the apparatus comprising:
a) a first and a second substantially circular frame detachably mounted to a base frame in a parallel spaced apart orientation;
b) a plurality of mounting members adjustably mounted to said first and said second substantially circular frame, said mounting members adjustable to engage a support structure of the vehicle to detachably mount the vehicle to said first and said second substantially circular frame;
c) a plurality of rotatable bearings mounted to said base, said first and said second substantially circular frame engaging said plurality of rotatable bearings when said first and second substantially circular frame is mounted to said base; and
d) a plurality of releasable locking mechanisms mounted to said base frame, said locking mechanisms engaging said first and said second circular frame when in a secured position so as to inhibit rotation of said first and second circular frame;
wherein said first and said second circular frame may freely rotate simultaneously on said plurality of bearings in a first and a second direction when said plurality of locking mechanisms are in a released position;
wherein said first and said second circular frame rotates relative to said base frame resting stationary on a surface; and
wherein said plurality of mounting members are adjustable to engage the vehicle at a plurality of different positions so as to provide virtually complete access to an underside of the vehicle.

2. The apparatus of claim 1 wherein an upper planar cross member forms at an upper portion of each of said first and said second substantially circular frame.

3. The apparatus of claim 2 wherein a first sleeve member is mounted to a first and a second end of each upper cross member, each of said first sleeve members configured to adjustably receive a first and a second upper side bar that extends between said first and said second substantially circular frame so as to adjust distance between said first and said second substantially circular frame.

4. The apparatus of claim 3 wherein each of said first and said second substantially circular frame further comprises a lower planar cross member extending between a lower curved portion of each of said first and said second substantially circular frame.

5. The apparatus of claim 4 wherein a pair of adjustable sleeve members are mounted to each of said lower cross members such that each of said pair of adjustable sleeve members may translate in a first and a second direction along said lower cross member so as to adjust distance between said pair of adjustable sleeve members.

6. The apparatus of claim 5 wherein each of said adjustable sleeve members support one of said plurality of mounting members, said mounting members comprising pinch weld mounting members configured to engage and secure onto a rocker panel pinch weld of an automobile.

7. The apparatus of claim 6 wherein said base frame comprises a pair of end bars in a parallel spaced apart orientation and a pair of lower side bars in a parallel spaced apart orientation, said pair of lower side bars adjustably coupled with said pair of end bars such that said base frame is generally rectangular.

8. The apparatus of claim 7 wherein a second sleeve member is mounted to a first and a second exterior end of each end bar, each of said second sleeve members configured to adjustably receive said side bars so as to adjust position of said mounting members relative to a longitudinal length of said rocker panel pinch weld.

9. The apparatus of claim 8 wherein a wheel may be attached to each end of said pair of lower side bars so as to enable the apparatus to be transported to another location while the vehicle is mounted to the apparatus.

10. The apparatus of claim 9 further comprising a pair of support plates mounted to a first and a second interior end of each of said end bars wherein an upper end of each of said pair of support plates rotatably supports one of said a plurality of rotatable bearings by way of a pivot pin.

11. The apparatus of claim 10 wherein said upper end of each of said support plates extend above said bearing as a guide to inhibit disengagement of said first and said second frame with said bearings.

12. The apparatus of claim 11 further comprising a pair of centre plates mounted to a generally central region of each end bar wherein each of said pair of centre plates supports one of said plurality of releasable locking mechanisms, said locking mechanism comprising a pair of corresponding apertures on an upper end of each of said pair of centre plates and a bolt that may journal through said pair of apertures.

13. The apparatus of claim 12 wherein said first and said second substantially circular frame further comprises a plurality of apertures corresponding to different degrees of rotation, said plurality of apertures matching said pair of apertures on each of said pair of centre plates such that said bolt may journal through said apertures on said first and said second substantially circular frame and said pair of centre plates so as to lock said first and said second substantially circular frame in a desired degree of rotation.

14. An apparatus for rotating a vehicle, the apparatus comprising:
a) a first and a second substantially circular frame detachably mounted to a base frame in a parallel spaced apart orientation;
b) a plurality of pinch weld mounting members adjustably mounted to said first and said second substantially circular frame, said pinch weld mounting members adjustable to engage a rocker panel pinch weld on both sides of the vehicle to detachably mount the vehicle to said first and said second substantially circular frame;
c) a plurality of rotatable bearings mounted to said base, said first and said second substantially circular frame engaging said plurality of rotatable bearings when said first and second substantially circular frame is mounted to said base; and
d) a plurality of releasable locking mechanisms mounted to said base frame, said locking mechanisms engaging said first and said second circular frame when in a first secured position so as to inhibit rotation of said first and second circular frame;
wherein said first and said second circular frame may freely rotate simultaneously on said plurality of bearings in a first and a second direction when said plurality of locking mechanisms are in a second released position;
wherein said first and said second circular frame rotates relative to said base frame resting stationary on a surface; and
wherein said pinch weld mounting members may be adjustably mounted to a plurality of different locations along said rocker panel pinch weld so as to provide virtually complete access to an underside of the vehicle.

15. The apparatus of claim 14 wherein an upper planar cross member forms at an upper portion of each of said first and said second substantially circular frame.

16. The apparatus of claim 15 wherein a first sleeve member is mounted to a first and a second end of each upper cross member, each of said first sleeve members configured to adjustably receive a first and a second upper side bar that extends between said first and said second substantially circular frame so as to adjust distance between said first and said second substantially circular frame.

17. The apparatus of claim 16 wherein each of said first and said second substantially circular frame further comprises a lower planar cross member extending between a lower curved portion of each of said first and said second substantially circular frame.

18. The apparatus of claim 17 wherein a pair of adjustable sleeve members are mounted to each of said lower cross members such that each of said pair of adjustable sleeve members may translate in a first and a second direction along said lower cross member so as to adjust distance between said pair of adjustable sleeve members.

19. The apparatus of claim 18 wherein each of said adjustable sleeve members support one of said plurality of pinch weld mounting members.

20. The apparatus of claim 19 wherein said base frame comprises a pair of end bars in a parallel spaced apart orientation and a pair of lower side bars in a parallel spaced apart orientation, said pair of lower side bars adjustably coupled with said pair of end bars such that position of said pinch weld mounting members may be adjusted along longitudinal length of said rocker panel pinch weld.
